(19) United States
(12) Patent Application Publication
(10) Pub. No.: US 2022/0277475 A1
(43) Pub. Date: Sep. 1, 2022

(54) FEATURE EXTRACTION METHOD AND DEVICE, AND POSE ESTIMATION METHOD USING SAME

(71) Applicant: GUANGDONG OPPO MOBILE TELECOMMUNICATIONS CORP., LTD, Dongguan (CN)

(72) Inventors: Yang ZHOU, Palo Alto, CA (US); Jie LIU, Palo Alto, CA (US)

(21) Appl. No.: 17/745,565

(22) Filed: May 16, 2022

Related U.S. Application Data
(63) Continuation of application No. PCT/CN2020/127867, filed on Nov. 10, 2020.
(60) Provisional application No. 62/938,183, filed on Nov. 20, 2019.

(51) Int. Cl. G06T 7/73; G06V 10/40; G06T 3/40; G06V 10/22; G06V 40/10; G06V 10/77

(52) U.S. Cl. CPC G06T 7/73; G06V 10/40; G06T 3/40; G06V 10/225; G06V 40/11; G06V 10/7715; G06T 2207/10028; G06T 2207/30196

(57) ABSTRACT

Feature extraction method, apparatus and device, and a storage medium are provided. Pose estimation method, apparatus and device, and another storage medium using the feature extraction method also are provided. By employing the feature extraction method, in a feature extraction stage, a feature of a depth image to be recognized is extracted to determine a basic feature of the depth image; then multiple features of different scales of the basic feature are extracted to determine a multi-scale feature of the depth image; and finally, the multi-scale feature is up-sampled to enrich the feature again. In the foregoing manner, more diverse features can be extracted from the depth image by the use of the feature extraction method. When pose estimation is performed on the basis of the feature extraction method, the enriched feature can also improve the accuracy of subsequent bounding box and pose estimation.

### CROSS-REFERENCE TO RELATED APPLICATIONS

This application is a continuation of International Application No. PCT/CN2020/127867, filed Nov. 10, 2020, which claims priority to U.S. Provisional Patent Application No. 62/938,183, filed Nov. 20, 2019, the entire disclosures of which are incorporated herein by reference.

### TECHNICAL FIELD

The disclosure relates to image processing technologies, and more particularly to feature extraction method, apparatus and device; pose estimation method, apparatus and device; and storage mediums.

### BACKGROUND

Nowadays, hand pose recognition technology has broad market application prospects in many fields such as immersive virtual and augmented realities, robotic control and sign language recognition. The technology has been great progress in recent years, especially with the arrival of consumer depth cameras. However, the accuracy of hand pose recognition is low due to unconstrained global and local pose variations, frequent occlusion, local self-similarity and a high degree of articulation. Therefore, the hand pose recognition technology still has a high research value.

### SUMMARY

In view of the above technical problem, embodiments of the disclosure provide a feature extraction method, a feature extraction device, and a pose estimation method.

In a first aspect, an embodiment of the disclosure provides a feature extraction method. The feature extraction method includes: extracting a feature of a depth image to be recognized to determine a basic feature of the depth image; extracting a plurality of features of different scales of the basic feature to determine a multi-scale feature of the depth image; and up-sampling the multi-scale feature to determine a target feature. The target feature is configured (i.e., structured and arranged) to determine a bounding box of a region of interest (RoI) in the depth image.

In a second aspect, an embodiment of the disclosure provides a feature extraction device. The feature extraction device includes: a first processor and a first memory for storing a computer program runnable on the first processor. The first memory is configured to store a computer program, and the first processor is configured to call and run the computer program stored in the first memory to execute the steps of the method in the first aspect.

In a third aspect, an embodiment of the disclosure provides a pose estimation method.

The pose estimation method includes: extracting a feature of a depth image to be recognized to determine a basic feature of the depth image; extracting a plurality of features of different scales of the basic feature to determine a multi-scale feature of the depth image; up-sampling the multi-scale feature to determine a target feature; extracting, based on the target feature, a bounding box of a RoI; extracting, based on the bounding box, coordinate information of keypoints in the RoI; and performing pose estimation, based on the coordinate information of the keypoints in the RoI, on a detection object, to determine a pose estimation result.

### BRIEF DESCRIPTION OF THE DRAWINGS

FIG. 1 illustrates a schematic view of an image captured by a TOF (time of flight) camera according to a related art.

FIG. 2 illustrates a schematic view of a hand bounding box detection result according to a related art.

FIG. 3 illustrates a schematic view of locations of keypoints of a hand skeleton according to a related art.

FIG. 4 illustrates a schematic view of a 2D (two-dimensional) hand pose estimation result according to a related art.

FIG. 5 illustrates a schematic view of an existing hand pose detection pipeline according to a related art.

FIG. 6 illustrates a schematic view of RoIAlign feature extraction according to a related art.

FIG. 7 illustrates a schematic view of non-maximum suppression according to a related art.

FIG. 8a and FIG. 8b illustrate schematic views of intersection-over-union according to a related art.

FIG. 9 illustrates a schematic view of Alexnet architecture.

FIG. 10 illustrates a schematic flowchart of a hand pose estimation according to an embodiment of the disclosure.

FIG. 11 illustrates a schematic flowchart of a feature extraction method according to an embodiment of the disclosure.

FIG. 12 illustrates a schematic flowchart of another feature extraction method according to an embodiment of the disclosure.

FIG. 13 illustrates a schematic structural view of a backbone feature extractor according to an embodiment of the disclosure.

FIG. 14 illustrates a schematic structural view of a feature extraction apparatus according to an embodiment of the disclosure.

FIG. 15 illustrates a schematic structural view of a feature extraction device according to an embodiment of the disclosure.

FIG. 16 illustrates a schematic flowchart of a pose estimation method according to an embodiment of the disclosure.

FIG. 17 illustrates a schematic structural view of a pose estimation apparatus according to an embodiment of the disclosure.

FIG. 18 illustrates a schematic structural view of a pose estimation device according to an embodiment of the disclosure.

### DETAILED DESCRIPTION OF EMBODIMENTS

In order to understand features and technical contents of embodiments of the disclosure in more detail, the following is a detailed description of the implementation of the embodiments of the disclosure in conjunction with accompanying drawings. The attached drawings are for illustrative purposes only and are not intended to limit the embodiments of the disclosure.

Hand pose estimation mainly refers to an accurate estimation of 3D coordinate locations of human hand skeleton nodes from an image, which is a key problem in the field of computer vision and human-computer interaction, and is of great significance in the fields such as virtual and augmented realities, non-contact interaction and hand pose recognition. With the rise and development of commercial, inexpensive depth cameras, the hand pose estimation has been great progress.

The depth cameras include several types such as structured light, laser scanning and TOF, and in most cases the depth camera refers to TOF camera. Herein, TOF is the abbreviation of time of fight. A three-dimensional (3D) imaging of the so-called time-of-flight technique is transmitting light pulses to an object continuously, then using a sensor to receive light returned back from the object and acquiring target distances from the object by measuring flight times (round-trip times) of the light pulses. Specifically, the TOF camera is a range imaging camera system that uses the time-of-flight technique to resolve the distance between the TOF camera and the captured object for each point of the image by measuring the round-trip time of an artificial light signal provided by a laser or a light emitting diode (LED).

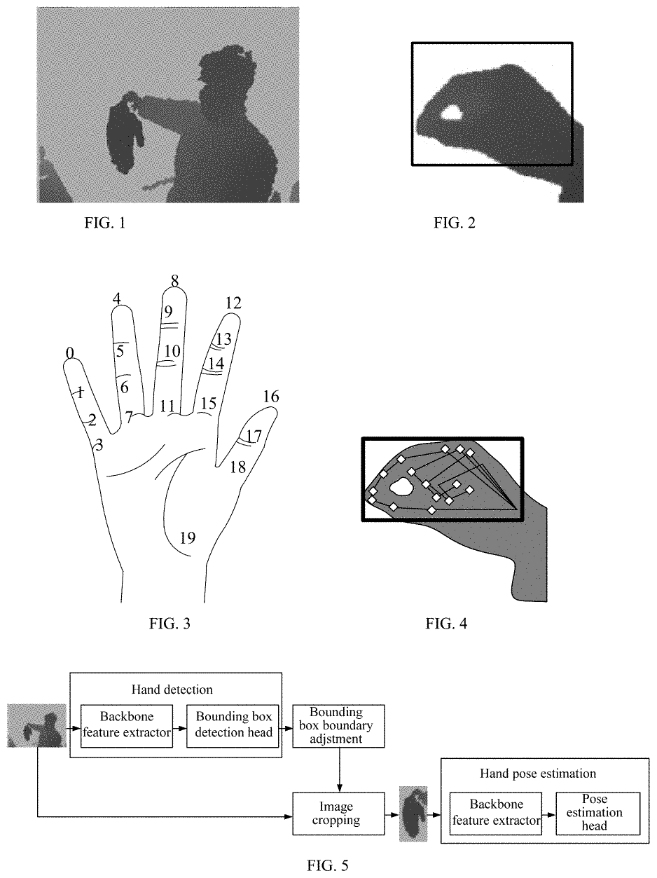

The TOF camera outputs an image with a size of H×W, a value of each pixel on the 2D image may represent a depth value of the pixel, and the value of each pixel is in a range of 0˜3000 millimeters (mm). FIG. 1 illustrates a schematic view of an image captured by a TOF camera according to a related art. In at least one embodiment of the disclosure, the image captured by such TOF camera can be regarded as a depth image.

Compared with other commodity TOF cameras, a TOF camera provided by the manufacturer “O” may have the following differences: (1) it can be installed in a mobile phone instead of fixed on a static stand; (2) it has lower power consumption than the other commodity TOF cameras such as Microsoft Kinect or Intel Realsense; and (3) it has lower image resolution, e.g., 240×180 compared to typical 640×480.

It can be understood that, hand detection is a process of inputting a depth image, and then outputting a probability of hand presence (i.e., a numerical number from 0 to 1, a large value represents a large confidence of hand presence) and a hand bounding box (i.e., a bounding box representing location and size of a hand). FIG. 2 illustrates a schematic view of a hand bounding box detection result according to a related art. As shown in FIG. 2, the black rectangle box is the hand bounding box, and a score of the hand bounding box is up to 0.999884.

In at least one embodiment of the disclosure, the bounding box may also be referred to as boundary frame. Herein, the bounding box may be represented as (xmin, ymin, xmax, ymax), where (xmin, ymin) is the left top corner of the bounding box, and (xmax, ymax) is the right down corner of the bounding box.

Specifically, in a process of a 2D hand pose estimation, an input is a depth image, and an output is 2D keypoint locations of the hand skeleton, and an example of the keypoint locations of the hand skeleton is shown by FIG. 3. In FIG. 3, the hand skeleton can be set with 20 numbers of keypoints, and locations of the keypoints are labelled as 0-19 in FIG. 3. Herein, the location of each the keypoint can be represented by a 2D coordinate (x, y), where x is the coordinate information on a horizontal image axis, and y is the coordinate information on a vertical image axis. In some embodiments, after the coordinates of the 20 numbers of keypoints are determined, a 2D hand pose estimation result may be obtained as shown in FIG. 4.

In a process of a 3D hand pose estimation, an input also is a depth image, and an output is 3D keypoint locations of the hand skeleton, and an example of the keypoint locations of the hand skeleton also is shown by FIG. 3. Herein, the location of each the keypoint can be represented by a 3D coordinate (x, y, z), where x is the coordinate information on a horizontal image axis, y is the coordinate information on a vertical image axis, and z is the coordinate information on a depth direction. At least one embodiment of the disclosure is working on the 3D hand pose estimation problem.

Nowadays, a typical hand pose detection pipeline may include a hand detection part and a hand pose estimation part. The hand detection part may include a backbone feature extractor and a bounding box detection head. The hand pose estimation part may include a backbone feature extractor and a pose estimation head. Illustratively, FIG. 5 shows a schematic view of an existing hand pose estimation pipeline according to a related art. As illustrated in FIG. 5, after a raw depth image including a hand is obtained, a hand detection may be carried out firstly, i.e., using the backbone feature extractor and the bounding box detection head included in the hand detection part to carry out the detection of hand, and at this situation the boundary of the bounding box may be adjusted. The adjusted bounding box then is used to crop the image, and the cropped image is performed with hand pose estimation, i.e., using the backbone feature extractor and the pose estimation head included in the hand pose estimation part to carry out the hand pose estimation. It is indicated that, the tasks of hand detection and hand pose estimation are completely separated. To connect the two tasks, an output position of the bounding box is adjusted to a mass center of pixels inside the bounding box, and a size of the bounding box may be enlarged a little to include all hand pixels. The adjusted bounding box is used to crop the raw depth image. The cropped image is fed into the task of hand pose estimation. Herein, when backbone feature extractor is applied twice to extract image features, it will lead to duplicated computation, resulting in an increase of computational amount.

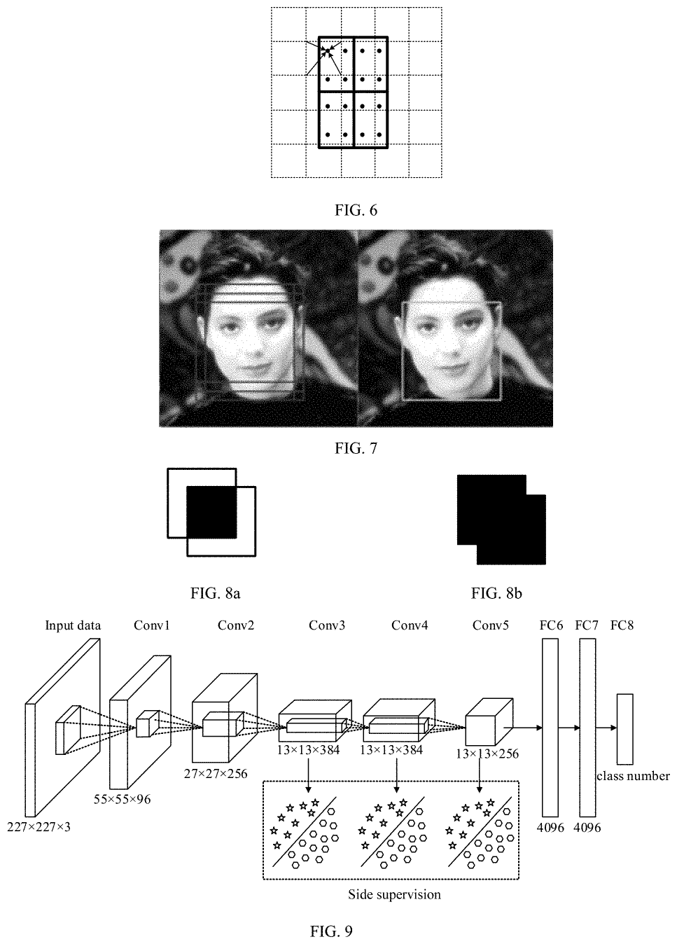

In this case, RoIAlign may be introduced. RoIAlign is a region of interest (RoI) feature aggregation method, which can well solve the problem of region mismatch caused by two times of quantizations in a RoI Pool operation. In a task of detection, replacing RoI Pool with RoIAlign can improve the accuracy of detection result. That is, RoIAlign can remove harsh quantization of RoIPool, properly aligning the extracted feature with the input. Herein, it can avoid any quantization of RoI boundaries or bins, for example, x/16 may be used instead of [x/16]. In addition, a bilinear interpolation may be used to compute exact values of input feature at four regularly sampled locations in each RoI bin, and the result then is aggregated (using max or average), as shown in FIG. 6. In particular, in FIG. 6, the dashed grid represents a feature map, the bold solid lines represent an RoI (with 2×2 bins), and there are four sampling points in each bin. RoIAlign computes a value of each sampling point by bilinear interpolation from nearby grid points on the feature map. No quantization is performed on any coordinates involved in the RoI, its bins or the sampling points. It is noted that, the detection result is not sensitive to the exact sampling locations or how may points are sampled, as long as no quantization is performed.

In addition, non-maximum suppression (NMS) has been widely used in several key aspects of computer vision and is an integral part of many proposed approaches in detection, might it be edge, corner or objection detection. Its necessity stems from the imperfect ability of detection algorithms to localize the concept of interest, resulting in groups of several detections near the real location.

In the context of object detection, an approach based on sliding windows generally produce multiple windows with high scores close to a correct location of object. This is a consequence of generalization ability of object detector, smoothness of response function and visual correlation of close-by windows. This relatively dense output is generally not satisfactory for understanding the content of an image. As a matter of fact, the number of window hypotheses at this step is simply uncorrelated with the real number of objects in the image. A goal of NMS is therefore to retain only one window per detection group, corresponding to a precise local maximum of the response function, ideally obtaining only one detection per object. One example of NMS is shown in FIG. 7, and the goal of NMS is to retain only one window (see the bold gray rectangle box in FIG. 7).

As illustrated in FIGS. 8a and 8b, schematic views of intersection-over-union according to a related art are shown. In FIG. 8a and FIG. 8b, two bounding boxes are given, respectively are BB1 and BB2. Herein, the black region in FIG. 8a is an intersection of BB1 and BB2, denoted as BB1∩BB2, which is defined as the overlapped region of BB1 and BB2. The black region in FIG. 8b is the union of BB1 and BB2, denoted as BB1∪BB2, which is defined as the union region of BB1 and BB2. More specifically, a calculation formula of intersection over union (represented by IoU) is as follows:

$$IoU = \frac{Area of Overlap}{Area of Union} = \frac{BB 1 ⋂ BB 2}{BB 1 ⋃ BB 2}$$

On the basis of the above context of detection, a current scheme of hand pose estimation is Alexnet, and FIG. 9 illustrates a schematic structural view of Alexnet architecture. In particular, an input image is sequentially passed through five consecutively connected convolutional layers (i.e., Conv1, Conv2, Conv3, Conv4 and Conv5), and then through three fully connected layers (i.e., FC6, FC7 and FC8). However, Alexnet requires lots of computation and thus is without being designed for mobile devices, and therefore it is difficult to be implemented on mobile devices.

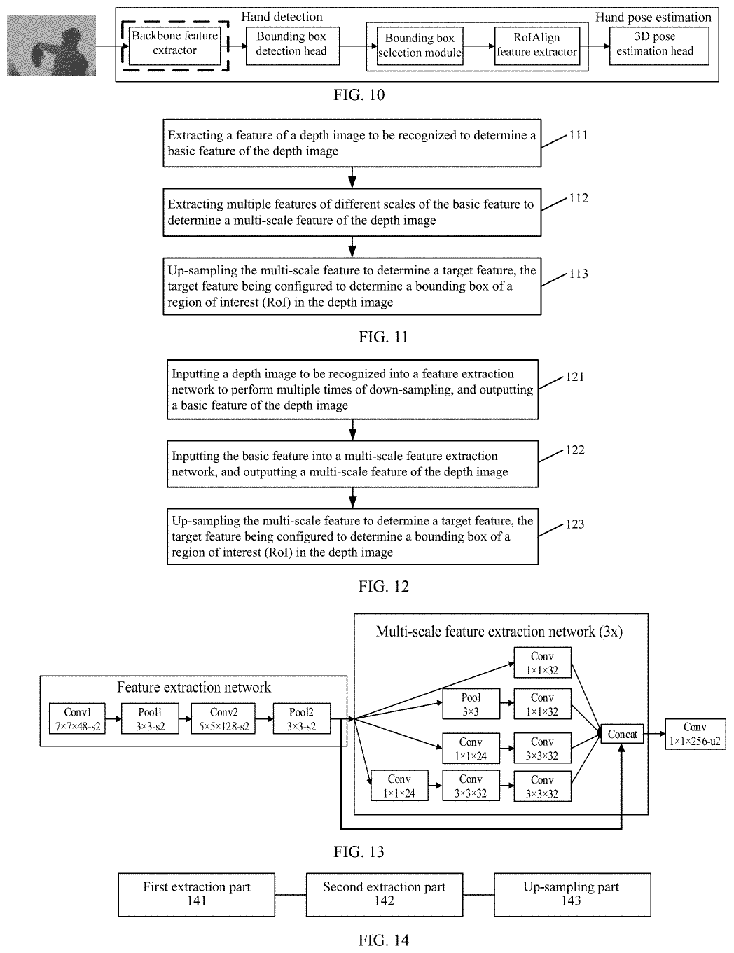

To address the above problem, an embodiment of the disclosure provides a feature extraction method that can be implemented in a backbone feature extractor. Different from the application of the backbone feature extractor in FIG. 5, FIG. 10 illustrates a schematic flowchart of a hand pose estimation according to an embodiment of the disclosure. As shown in FIG. 10, a backbone feature extractor according to the embodiment of the disclosure is placed after an input and before a bounding box detection head, it can extract more image features for hand detection and hand pose estimation, and compared with the existing extraction method, the detection network is more compact and more suitable for deployment on mobile devices.

In the following, a detailed description of the feature extraction method according to the embodiment of the disclosure will be given.

In an illustrative embodiment of the disclosure, a schematic flowchart of the feature extraction method is shown. As illustrated in FIG. 11, the feature extraction method may begin from block 111 to block 113.

At the block 111: extracting a feature of a depth image to be recognized to determine a basic feature of the depth image.

In at least one embodiment, before the block 111, the feature extraction method may further include: acquiring the depth image, captured by a depth camera, containing a detection object. The depth camera may exist independently or be integrated onto an electronic device. The depth cameras can be a TOF camera, a structured light depth camera, or a binocular stereo vision camera. At present, TOF cameras are more used in mobile terminals.

In actual applications, the basic feature of the depth image can be extracted through an established feature extraction network. The feature extraction network may include at least one convolution layer and at least one pooling layer connected at intervals, and the starting layer is one of the least one convolution layer. The at least one convolution layer may have the same or different convolutional kernels, and the at least one pooling layer may have the same convolutional kernel. In an illustrative embodiment, the convolutional kernel of each the convolution layer may be any one of 1×1, 3×3, 5×5 and 7×7, and the convolutional kernel of the pooling layer also may be any one of 1×1, 3×3, 5×5 and 7×7.

In at least one embodiment, the pooling operation may be a Max pooling or an average pooling, and the disclosure is not limited thereto.

In at least one embodiment, the basic feature includes at least one of color feature, texture feature, shape feature, spatial relationship feature and contour feature. The basic feature having higher resolution can contain more location and detail information, which can provide more useful information for positioning and segmentation, allowing a high-level network to obtain image context information more easily and comprehensively based on the basic feature, so that the context information can be used to improve positioning accuracy of subsequent ROI bounding box.

In at least one embodiment, the basic feature may also refer to a low-level feature of the image.

In at least one embodiment, an expression form of the feature may include, for example, but is not limited to a feature map, a feature vector, or a feature matrix.

At the block 112: extracting multiple (i.e., more than one) features of different scales of the basic feature to determine a multi-scale feature of the depth image.

Specifically, the multi-scale feature is convoluted with multiple setting scales, and then multiple convolution results are performed with an add operation to obtain different image features at multiple scales.

In actual applications, a multi-scale feature extraction network can be established to extract image features at different scales of the basic features. In an illustrative embodiment, the multi-scale feature extraction network may include consecutively connected N convolutional networks, where N is an integer greater than 1.

In at least one embodiment, when N is greater than 1, the N convolutional networks may be the same convolutional network or different convolutional networks, an input of the first one of the N convolutional networks is the basic feature, an input of each the other convolutional network is an output of a preceding convolutional network, and an output of the Nth convolutional network is the multi-scale feature finally output by the multi-scale feature extraction network.

In some embodiments, the N convolutional networks are the same convolutional network, i.e., repeated N convolutional networks are sequentially connected, which is beneficial to reduce complexity of network and reduce the amount of computation.

In some embodiments, for each the convolutional network, an input feature and an initial output feature thereof are concatenated, and the concatenated feature is used as a final output feature of the convolutional network. For example, a skip connection is added in each the convolutional network to concatenate the input feature and the initial output feature, which can solve the problem of gradient disappearance in the case of deep network layers and also help back propagation of gradient to thereby speed up a training process.

At the block 113: up-sampling the multi-scale feature to determine a target feature. The target feature is configured to determine a bounding box of a RoI in the depth image.

In actual applications, the up-sampling refers to any technique that allows an image to become higher resolution. The up-sampling of the multi-scale feature can give more detailed features of the image and facilitate subsequent detection of bounding box. A simplest way is re-sampling and interpolation, i.e., rescaling an input image to a desired size and calculating pixels of each point, and performing interpolation such as bilinear interpolation on the rest of points to complete the up-sampling process.

In addition, when the obtained image feature is used for pose estimation, the bounding box of the RoI in the depth image is determined firstly based on the target feature, coordinate information of keypoints in the RoI is then extracted based on the bounding box, and pose estimation is performed subsequently based on the coordinate information of the keypoints in the RoI to determine a pose estimation result.

More specifically, the detection object may include a hand. The keypoints may include at least one of the following that: finger joint points, fingertip points, a wrist keypoint and a palm center point. When performing hand pose estimation, hand skeleton key nodes are keypoints, usually the hand includes 20 numbers of keypoints, and specific locations of the 20 numbers of keypoints on the hand are shown in FIG. 3.

Alternatively, the detection object may include a human face, the keypoints may include at least one of the following that: eye points, eyebrow points, a mouth point, a nose point and face contour points. When performing face expression recognition, the face keypoints are specifically keypoints of the five sense organs of the face and can have 5 numbers of keypoints, 21 numbers of keypoints, 68 numbers of keypoints, or 98 numbers of keypoints, etc.

In another embodiment, the detection object may include a human body, and the keypoints may include at least one of the following that: head points, limb joint points, and torso points, and can have 28 numbers of keypoints.

In actual applications, the feature extraction method according to at least one embodiment of the disclosure may be applied in a feature extraction apparatus or an electronic device integrated with the apparatus. The electronic device may be a smart phone, a tablet, a laptop, a palmtop computer, a personal digital assistant (PDA), a navigation device, a wearable device, a desktop computer, etc., and the embodiments of the disclosure are not limited thereto.

The feature extraction method according to at least one embodiment of the disclosure may be applied in the field of image recognition, the extracted image feature can be involved in a whole human body pose estimation or local pose estimation. The illustrated embodiments mainly introduce how to estimate the hand pose, pose estimations of other parts where the feature extraction method is applied are also within the scope of protection of the disclosure.

When the feature extraction method according to the disclosure is employed, in the feature extraction stage, the basic feature of the depth image is determined by extracting the features of the depth image to be recognized; a plurality of features of different scales of the basic feature are then extracted and the multi-scale feature of the depth image is determined; and finally the multi-scale feature is up-sampled to enrich the feature again. In this way, more diverse features can be extracted from the depth image using the feature extraction method, and when pose estimation is performed based on the feature extraction method, the enriched feature can also improve the accuracy of subsequent bounding box and pose estimation.

In another embodiment of the disclosure, as illustrated in FIG. 12, a schematic flowchart of another feature extraction method is provided. In particular, as shown in FIG. 12, the method may begin from block 121 to block 123.

At the block 121: inputting a depth image to be recognized into a feature extraction network to carry out multiple times of down-sampling, and outputting a basic feature of the depth image.

Herein, the feature extraction network may include at least one convolutional layer and at least one pooling layer connected at intervals, and a starting layer is one of the at least one convolutional layer.

In some embodiments, in the at least one convolutional layer, a convolutional kernel of the convolutional layer close to an input end (of the feature extraction network) is larger than or equal to a convolutional kernel of the convolutional layer far away from the input end. In an illustrative embodiment, the convolutional kernel may be any one of 1×1, 3×3, 5×5 and 7×7; and the convolutional kernel of the pooling layer also may be any one of 1×1, 3×3, 5×5 and 7×7.

It is noted that, a large convolutional kernel can quickly enlarge a receptive field and extract more image features, but there is the problem of large computational amount. Therefore, the embodiment of the disclosure uses a manner of convolutional kernel being decreased layer-by-layer to make a good balance between image features and computational amount, which can ensure the computational amount to be suitable for processing power of a mobile terminal on the basis of extracting more basic features.

FIG. 13 illustrates a schematic structural view of a backbone feature extractor according to an embodiment of the disclosure. As shown in FIG. 13, the backbone feature extractor may include a feature extraction network, a multi-scale feature extraction network and an up-sampling network. Specifically, the feature extraction network as shown has two convolutional layers and two pooling layers, which include Conv1 in 7×7×48, namely its convolutional kernel is 7×7 and the number of its channels is 48, s2 representing two times of down-sampling on two-dimensional data of the input depth image, and further include Pool1 in 3×3, Conv2 in 5×5×128, and Pool2 in 3×3.

In an illustrative embodiment, a depth image of 240×180 is firstly input into Conv1 in 7×7×48, the Conv1 in 7×7×48 outputs a feature map of 20×132×128, the Pool1 in 3×3 outputs a feature map of 60×45×48, the Conv2 in 5×5×128 outputs a feature map of 30×23×128, and the Pool2 in 3×3 outputs a feature map of 15×12×128. Each time of convolutional or pooling operation is performed with two times of down-sampling, and the input depth image is directly down-sampled for 16 times in total, so that the computational cost can be greatly reduced by the down-sampling. Herein, the use of large convolutional kernels such as 7×7 and 5×5 can quickly enlarge the receptive field and extract more image features.

In some embodiments, before the block 121, a depth image, captured by a depth camera, containing a detection object is firstly acquired. The depth camera may exist independently or be integrated on an electronic apparatus. The depth camera may be a TOF camera, a structured light depth camera or a binocular stereo vision camera. At present, TOF cameras are more used in mobile terminals.

At the block 122: inputting the basic feature into a multi-scale feature extraction network and outputting a multi-scale feature of the depth image.

In particular, the multi-scale feature extraction network may include N convolutional networks sequentially connected, and N is an integer greater than 1.

More specifically, each the convolutional network may include at least two convolutional branches and a concatenating network, and the convolutional branches are used to extract features of respective different scales.

The inputting the basic feature into a multi-scale feature extraction network and outputting a multi-scale feature of the depth image may specifically include:

inputting an output feature of a (i−1)th convolutional network into an ith convolutional network, and outputting features of the at least two branches of the ith conventional network; where i is an integer changed from 1 to N, when i=1, the feature input into the 1st conventional network is the basic feature;

inputting, into the concatenating network for features concatenation, the features output by and the feature input into the ith convolutional network, and outputting an output feature of the ith convolutional network;

when i is smaller than N, continuing inputting the output feature of the ith convolutional network into a (i+1)th convolutional network;

when i is equal to N, outputting, by the Nth convolutional network, the multi-scale feature of the depth image.

In at least one embodiment, the number of channels of the output feature of the convolutional network should be the same as the number of channels of the input feature thereof, in order to perform features concatenation.

In at least one embodiment, each the convolutional network is used to extract diverse features, and the more backward the extracted feature is, the more abstract the feature is. For example, the preceding convolutional network can extract a more local feature, e.g., extract the feature of fingers, and the succeeding convolutional network extracts a more global feature, e.g., extracts the feature of the whole hand, and by using N repeated convolutional kernel groups, more diverse features can be extracted. Similarly, different convolutional branches in each the convolutional network also extract diverse features, e.g., some of the branches extracts a more detailed feature, and some of the branches extracts a more global feature.

In some embodiments, each the convolutional network may include four convolutional branches. In particular, a first convolutional branch may include a first convolutional layer, a second convolutional branch may include a first pooling layer and a second convolutional layer sequentially connected, a third convolutional branch may include a third convolutional layer and a fourth convolutional layer, and a fourth convolutional branch may include a fifth convolutional layer, a sixth convolutional layer and a seventh convolutional layer sequentially connected.

The first convolutional layer, the second convolutional layer, the fourth convolutional layer and the seventh convolutional layer have equal number of channels. The third convolutional layer and the fifth convolutional layer have equal number of channels which is smaller than the number of channels of the fourth convolutional layer.

It is noted that, the smaller number of channels for the third and fifth convolutional layers is to perform channel down-sampling on the input feature to thereby reduce the computational amount of subsequent convolutional processing, which is more suitable for mobile apparatuses. By setting four convolutional branches, a good balance between image features and computational amount can be made to ensure that the computational amount is suitable for the processing power of mobile terminals on the basis of extracting features of more scales.

In some embodiments, the first convolutional layer, the second convolutional layer, the third convolutional layer and the fifth convolutional layer have the same convolutional kernel; and the fourth convolutional layer, the sixth convolutional layer and the seventh convolutional layer have the convolutional kernel.

In an illustrative embodiment, the convolutional kernel of each of the first through seventh convolutional layers may be any one of 1×1, 3×3 and 5×5; and the convolutional kernel of the first pooling layer may also be any one of 1×1, 3×3 and 5×5.

FIG. 13 illustrates a schematic structural view of a backbone feature extractor according to an embodiment of the disclosure. As shown in FIG. 13, the backbone feature extractor may include a feature extraction network, a multi-scale feature extraction network and an up-sampling network. In particular, the multi-scale feature extraction network having three repeated convolutional networks is given. More specifically, the multi-scale feature extraction network include: a first convolutional branch including Cony in 1×1×32, namely its convolutional kernel is 1×1 and the number of channels thereof is 32; a second convolutional branch including Pool in 3×3 and Cony in 1×1×32; a third convolutional branch including Cony in 1×1×24 and Cony in 1×1×32 sequentially connected; and a fourth convolutional branch including Cony in 1×1×24, Cony in 1×1×32 and Cony in 1×1×32. Each the convolutional network is additionally added with a skip connection (i.e., concatenating network) to perform concatenation on the input features and the output feature, so as to achieve a more smooth gradient flow during training.

It is indicated that, for the multi-scale feature extraction network shown in FIG. 13, the topmost branch of the four convolutional branches included in the convolutional network extracts a more detailed feature, the middle two branches extract more localized features, and the last branch extracts a more global feature.

At the block 123: up-sampling the multi-scale feature to determine a target feature, where the target feature is configured to determine a bounding box of a RoI in the depth image.

Specifically, the multi-scale feature is input into an eighth convolutional layer and then the target feature is output. A number of channels of the eighth convolutional layer is M times of the number of channels of the multi-scale feature, where M is greater than 1.

In other words, by applying feature channel up-sampling on the multi-scale feature, more diverse features can be generated. M is an integer or non-integer greater than 1.

FIG. 13 illustrates a schematic structural view of a backbone feature extractor according to an embodiment of the disclosure. As shown in FIG. 13, the backbone feature extractor may include a feature extraction network, a multi-scale feature extraction network and an up-sampling network. The up-sampling network includes a convolutional layer being Cony in 1×1×256, u2 represents performing two times of up-sampling onto 2D data of the multi-scale feature, a convolutional kernel is added in 1×1×256 to up-sample from a feature map of 15×12×128 to a feature map of 15×12×256. By applying feature channel up-sampling, more diverse features can be generated.

In addition, when the target feature is used for pose estimation, a bounding box of a RoI in the depth image is firstly determined based on the target feature, coordinates of keypoints in the RoI are then extracted based on the bounding box, and pose estimation is finally performed on a detection object based on the coordinates of the keypoints in the RoI, to determine a pose estimation result.

In short, in at least one embodiment of the disclosure, the feature extraction method may mainly include the following design rules.

Rule #1, a network pipeline according to the disclosure includes three major components including: a basic feature extractor, a multi-scale feature extractor, and a feature up-sampling network. The network architecture is shown in FIG. 13.

Rule #2, wherein Rule #1, the basic feature extractor is used to extract a lower-level image feature (basic feature) A depth image of 240×180 is firstly in put into Conv1 in 7×7×48, and Conv1 in 7×7×48 outputs a feature map of 20×132×128, Pool1 in 3×3 outputs a feature map of 60×45×48, Conv2 in 5×5×128 outputs a feature map of 30×23×128, Pool2 in 3×3 outputs a feature map of 15×12×128. Herein, the input is directly down-sampled for 16 times, to largely reduce the computational cost. Large convolutional kernels (e.g., 7×7 and 5×5) are used to quickly enlarge receptive fields.

Rule #3, wherein Rule #1, the multi-scale feature extractor includes three repeated convolutional kernel groups, to extract more diverse features. In each convolutional kernel group, there are four branches, each branch extracts one type of image feature, the four branches (each branch outputs a 32-channel feature map) are combined into a 128-channel feature map.

Rule #4, wherein Rule #3, a skip connection is additionally added so as to be added to the 128-channel feature map, for more smooth gradient flow during training.

Rule #5, wherein Rule #1, a convolutional kernel is added in 1×1×256 to up-sample from a feature map of 15×12×128 to a feature map of 15×12×256. By applying feature channel up-sampling, more diverse features can be generated.

When the feature extraction method according to the disclosure is employed, in the feature extraction stage, the basic feature of the depth image is determined by extracting the feature of the depth image to be recognized; multiple features at different scales of the basic feature then are extracted and the multi-scale feature of the depth image is determined; and finally the multi-scale feature is up-sampled to enrich the feature again. In this way, more diverse features can be extracted from the depth image using the feature extraction method, and when pose estimation is performed based on the feature extraction method, the enriched feature can also improve the accuracy of subsequent bounding box and pose estimation.

In order to realize the feature extraction method according to the disclosure, based on the same inventive concept, an embodiment of the disclosure provides a feature extraction apparatus. As illustrated in FIG. 14, the feature extraction apparatus may include: a first extraction part 141, a second extraction part 142, and an up-sampling part 143.

The first extraction part 141 is configured to extract a feature of a depth image to be recognized to determine a basic feature of the depth image.

The second extraction part 142 is configured to extract a plurality of features of different scales of the basic feature to determine a multi-scale feature of the depth image.

The up-sampling part 143 is configured to up-sample the multi-scale feature to determine a target feature, where the target feature is configured to determine a bounding box of a RoI in the depth image.

In some embodiments, the first extraction part 141 is configured to input the depth image to be recognized into a feature extraction network to do multiple times of down-sampling and output the basic feature of the depth image. The feature extraction network may include at least one convolutional layer and at least one pooling layer alternately connected, and a starting layer is one of the at least one convolutional layer.

In some embodiments, a convolutional kernel of the convolutional layer close to the input end in the at least one convolutional layer is larger than or equal to a convolutional kernel of the convolutional layer far away from the input end.

In some embodiments, the feature extraction network includes two convolutional layers and two pooling layers. A convolutional kernel of the first one of the two convolutional layers is 7×7, and a convolutional kernel of the second one of the two convolutional layers is 5×5.

In some embodiments, the second extraction part 142 is configured to input the basic feature into a multi-scale feature extraction network and outputting the multi-scale feature of the depth image. The multi-scale feature extraction network may include N convolutional network sequentially connected, and N is an integer greater than 1.

In some embodiments, each the convolutional network includes at least two convolutional branches and a concatenating network, and different ones of the at least two convolutional branches are configured to extract features of different scales respectively;

correspondingly, the second extraction part 142 is configured to: input an output feature of a (i−1)th convolutional network into an ith convolutional network; output features of the at least two branches of the ith convolutional network, where i is an integer changed from 1 to N, and when i=1, the input feature of the 1st convolutional network is the basic feature; input, into the concatenating network for features concatenation, the features output by and the feature input into the ith convolutional network; output an output feature of the ith convolutional network; continue inputting the output feature of the ith convolutional network into a (i+1)th convolutional network, when i is less than N; and output the multi-scale feature of the depth image by the Nth convolutional network, when i is equal to N.

in some embodiments, the convolutional network includes four convolutional branches. In particular, a first convolutional branch includes a first convolutional layer, a second convolutional branch includes a first pooling layer and a second convolutional layer sequentially connected, a third convolutional branch includes a third convolutional layer and a fourth convolutional layer sequentially connected, and a fourth convolutional branch includes a fifth convolutional layer, a sixth convolutional layer and a seventh convolutional layer sequentially connected.

The first convolutional layer, the second convolutional layer, the fourth convolutional layer and the seventh convolutional layer have equal number of channels; and the third convolutional layer and the fifth convolutional layer have equal number of channels less than the number of channels of the fourth convolutional layer.

In at least one embodiment, the first convolutional layer is 1×1×32; the first pooling layer is 3×3 and the second convolutional layer is 1×1×32; the third convolutional layer is 1×1×24 and the fourth convolutional layer is 3×3×32; and the fifth convolutional layer is 1×1×24, the sixth convolutional layer is 3×3×32, and the seventh convolutional layer is 3×3×32.

In some embodiments, the up-sampling part 143 is configured to input the multi-scale feature into an eighth convolutional layer and output a target feature. A number of channels of the eighth convolutional layer is M times of a number of channels of the multi-scale feature, where M is greater than 1.

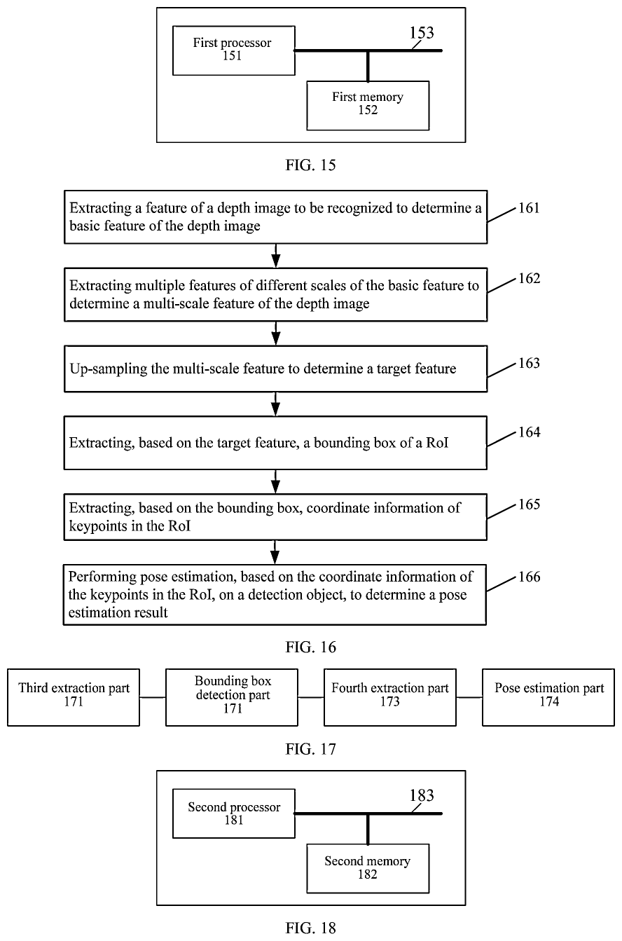

Based on a hardware implementation of the parts in the feature extraction apparatus described above, an embodiment of the disclosure provides a feature extraction device. As illustrated in FIG. 15, the feature extraction device may include a first processor 151 and a first memory 152 for storing a computer program runnable on the first processor 151.

Specifically, the first memory 152 is configured to store a computer program, and the first processor 151 is configured to call and run the computer program stored in the first memory 152 to execute the steps of the feature extraction method in any one of above embodiments.

Of course, in actual applications, as shown in FIG. 15, various components in the apparatus are coupled together through a first bus system 153. It can be understood that, the first bus system 153 is configured to realize connection and communication among these components. The first bus system 153 may include a power bus, a control bus and state signal bus, besides a data bus. However, for the sake of clarity, the various buses are labeled in FIG. 15 as the first bus system 153.

An embodiment of the disclosure provides a computer storage medium. The computer storage medium is stored with computer executable instructions, and the computer executable instructions can be executed to carry out the steps of the method in any one of above embodiments.

The above apparatus according to the disclosure, when implemented as software function modules and sold or used as a stand-alone product, may also be stored in a computer readable storage medium. Based on such understanding, the technical solutions of the embodiments of the disclosure essentially or characterizing parts thereof with respect to the related art, may be embodied in the form of computer software products, and the computer software product may be stored in a storage medium and include several instructions to enable computer apparatus (which may be a personal computer, a server, or network apparatus, etc.) to perform all or part of the method described in one of the various embodiments of the disclosure. The aforementioned storage medium may be: a USB flash drive, a removable hard disk, a read only memory (ROM, read only memory), a disk, a CD-ROM, or other medium that can store program codes. In this way, embodiments of the disclosure are not limited to any particular combinations of hardware and software.

Correspondingly, an embodiment of the disclosure provides a computer storage medium stored with a computer program, and the computer program is configured to execute the feature extraction method of any one of the above embodiments.

Based on the feature extraction method of at least one embodiment of the disclosure, a pose estimation method employing the feature extraction method also is provided. As shown in FIG. 16, the pose estimation method may begin from block 161 to block 166.

At the block 161: extracting a feature of a depth image to be recognized to determine a basic feature of the depth image.

Specifically, the depth image to be recognized is input into a feature extraction network to carry out multiple times of the down-sampling, and the basic feature of the depth image is then output. The feature extraction network may include at least one convolutional layer and at least one pooling layer connected at intervals, and a starting layer is one of the at least one convolutional layer.

In some embodiments, in the at least one convolutional layer, a convolutional kernel of the convolutional layer close to an input end is larger than or equal to a convolutional kernel of the convolutional layer far away from the input end.

In some embodiments, the feature extraction network includes two convolutional layers and two pooling layers. A convolutional kernel of the first one of the two convolutional layers is 7×7, and a convolutional kernel of the second one of the two convolutional layers is 5×5.

At the block 162: extracting a plurality of features of different scales of the basic feature to determine a multi-scale feature of the depth image.

In particular, the basic feature is input into a multi-scale feature extraction network, and the multi-scale feature of the depth image then is output. The multi-scale feature extraction network may include N convolutional networks sequentially connected, where N is an integer greater than 1.

In some embodiments, each the convolutional network may include at least two convolutional branches and a concatenating network, and different ones of the at least two convolutional branches are configured to extract features of different scales, respectively.

The basic features being input into a multi-scale feature extraction network, and the multi-scale feature of the depth image then being output, may include that: an output feature of a (i−1)th convolutional network is input into an ith convolutional network, and then features of at least two branches of the ith convolutional network are output; i is an integer changed from 1 to N, when i=1, the input feature of the 1st convolutional network is the basic feature; the features output by and the feature input into the ith convolutional network are input into the concatenating network for features concatenation, and then an output feature of the ith convolutional network is output; when i is smaller than N, the output feature of the ith convolutional network is continued to be input into a (i+1)th convolutional network; and when i is equal to N, the Nth convolutional network outputs the multi-scale feature of the depth image.

In some embodiments, each the convolutional network may include four convolutional branches. Specifically, a first convolutional branch includes a first convolutional layer, a second convolutional branch includes a first pooling layer and a second convolutional layer sequentially connected, a third convolutional branch includes a third convolutional layer and a fourth convolutional layer sequentially connected, and a fourth convolutional branch includes a fifth convolutional layer, a sixth convolutional layer and a seventh convolutional layer sequentially connected. The first convolutional layer, the second convolutional layer, the fourth convolutional layer and the seventh convolutional layer have equal number of channels; and the third convolutional layer and the fifth convolutional layer have equal number of channels less than the number of channels of the fourth convolutional layer.

In an illustrative embodiment, the first convolutional layer is 1×1×32; the first pooling layer is 3×3, and the second convolutional layer is 1×1×32; the third convolutional layer is 1×1×24, and the fourth convolutional layer is 3×3×32; and the fifth convolutional layer is 1×1×24, the sixth convolutional layer is 3×3×32, and the seventh convolutional layer is 3×3×32.

At the block 163: up-sampling the multi-scale feature to determine a target feature.

Specifically, the multi-scale feature is input into an eighth convolutional layer and then the target feature is output. A number of channels of the eighth convolutional layer is M times of a number of channels of the multi-scale feature, and M is greater than 1. More specifically, M is an integer or non-integer greater than 1.

At the block 164, extracting, based on the target feature, a bounding box of a RoI.

Specifically, the target feature is input into a bounding box detection head model to determine multiple candidate bounding boxes of the RoI, and one candidate bounding box is selected from the candidate bounding boxes as the bounding box surrounding the RoI.

At the block 165: extracting, based on the bounding box, coordinate information of keypoints in the RoI.

Herein, the region of interest (RoI) is an image region selected in the image, and the selected region is the focus of attention for image analysis and includes a detection object. The region is circled/selected to facilitate further processing of the detection object. Using the ROI to circle the detection object can reduce processing time and increase accuracy.

More specifically, the detection object may include a hand, and the keypoints may include at least one of the following that: finger joint points, fingertip points, a wrist keypoint and a palm center point. When performing hand pose estimation, hand skeleton key nodes are keypoints, usually the hand includes 20 numbers of keypoints, and specific locations of the 20 numbers of keypoints on the hand are shown in FIG. 3.

Alternatively, the detection object may include a human face, the keypoints may include at least one of the following that: eye points, eyebrow points, a mouth point, a nose point and face contour points. When performing face expression recognition, the face keypoints are specifically keypoints of the five sense organs of the face and can have 5 numbers of keypoints, 21 numbers of keypoints, 68 numbers of keypoints, or 98 numbers of keypoints, etc.

In another embodiment, the detection object may include a human body, and the keypoints may include at least one of the following that: head points, limb joint points, and torso points, and can have 28 numbers of keypoints.

At the block 166: performing pose estimation, based on the coordinate information of the keypoints in the RoI, on the detection object, to determine a pose estimation result.

When the feature extraction method according to the disclosure is employed, in the feature extraction stage, the basic feature of the depth image is determined by extracting the feature of the depth image to be recognized; a plurality of features at different scales of the basic feature then are extracted and the multi-scale feature of the depth image is determined; and finally the multi-scale feature is up-sampled to enrich the feature again. In this way, more diverse features can be extracted from the depth image using the feature extraction method, and when pose estimation is performed based on the feature extraction method, the enriched feature can also improve the accuracy of subsequent bounding box and pose estimation.

In order to implement the pose estimation method according to the disclosure, based on the same inventive concept, an embodiment of the disclosure provides a pose estimation apparatus. As illustrated in FIG. 17, the pose estimation apparatus may include: a third extraction part 171, a bounding box detection part 172, a fourth extraction part 173 and a pose estimation part 174.

The third extraction part 171 is configured to execute steps of the above feature extraction method to determine the target feature of the depth image to be recognized.

The bounding box detection part 172 is configured to extract, based on the target feature, a bounding box of a RoI.

The fourth extraction part 173 is configured to extract, based on the bounding box, location information of keypoints in the RoI.

The pose estimation part 174 is configured to perform pose estimation, based on the location information of the keypoints in the RoI, on a detection object.

Based on a hardware implementation of the parts in the pose estimation apparatus described above, an embodiment of the disclosure provides a pose estimation device. As illustrated in FIG. 18, the pose estimation device may include a second processor 181 and a second memory 182 for storing a computer program runnable on the second processor 181.

Specifically, the second memory 182 is configured to store a computer program, and the second processor 181 is configured to call and run the computer program stored in the second memory 182 to execute steps of the pose estimation method in any one of above embodiments.

Of course, in actual applications, as shown in FIG. 18, various components in the apparatus are coupled together through a second bus system 183. It can be understood that, the second bus system 183 is configure to realize connection and communication among these components. The second bus system 183 may include a power bus, a control bus and state signal bus, besides a data bus. However, for the sake of clarity, the various buses are labeled in FIG. 18 as the second bus system 183.

It is noted that in the disclosure, the terms “include”, “comprise” or any other variation thereof are intended to cover non-exclusive inclusion, such that a process, a method, an article, or an apparatus including a series of elements includes not only those elements, but also includes other elements that are not explicitly listed, or also includes elements inherent in such process, method, article or apparatus. Without further limitation, an element defined by the statement “including a” does not preclude the existence of additional identical element in the process, method, article or apparatus including the element.

It is noted that, “first”, “second”, etc. are used to distinguish similar objects and do not have to be used to describe a specific order or sequence.

The methods disclosed in various method embodiments of the disclosure can be combined arbitrarily on the prerequisite of without conflict, to obtain new method embodiments.

The characteristics disclosed in various apparatus embodiments of the disclosure can be combined arbitrarily on the prerequisite of without conflict, to obtain new apparatus embodiments.

The characteristics disclosed in the various method or device embodiments of the disclosure can be combined arbitrarily on the prerequisite of without conflict, to obtain new method embodiments or device embodiments.

The foregoing description is only specific implementations of the disclosure, but the scope of protection of the disclosure is not limited thereto, and any changes or substitutions readily conceivable by the skilled person in the art within the technical scope disclosed in the disclosure should be covered by the scope of protection of the disclosure. Therefore, the scope of protection of the disclosure should be subject to the scope of protection of the appended claims.

Industrial Practicality

The disclosure provides feature extraction method, apparatus and device and a storage medium, and also provides pose estimation method, apparatus and device and another storage medium using the feature extraction method. When the feature extraction method according to the disclosure is used, in the feature extraction stage, a basic feature of the depth image is determined by extracting a feature of the depth image to be recognized; a plurality of features at different scales of the basic feature then are extracted and a multi-scale feature of the depth image is determined; and finally the multi-scale feature is up-sampled to enrich the feature again. In this way, more diverse features can be extracted from the depth image using the feature extraction method, and when pose estimation is performed based on the feature extraction method, the enriched feature can also improve the accuracy of subsequent bounding box and pose estimation.

What is claimed is:

1. A feature extraction method comprising:
extracting a feature of a depth image to determine a basic feature of the depth image;
extracting a plurality of features of different scales of the basic feature to determine a multi-scale feature of the depth image; and
up-sampling the multi-scale feature to determine a target feature, wherein the target feature is configured to determine a bounding box of a region of interest (RoI) in the depth image.

2. The method as claimed in claim 1, wherein extracting the feature of the depth image to be recognized to determine the basic feature of the depth image comprises:
inputting the depth image into a feature extraction network to perform multiple times of down-sampling, and outputting the basic feature of the depth image.

3. The method as claimed in claim 2, wherein the feature extraction network comprises at least one convolutional layer and at least one pooling layer connected at intervals, and a starting layer is one of the at least one convolutional layer; and in the at least one convolutional layer, a convolutional kernel of the convolutional layer close to an input end is larger than or equal to a convolutional kernel of the convolutional layer far away from the input end.

4. The method as claimed in claim 3, wherein the feature extraction network comprises two the convolutional layers and two the pooling layers, the convolutional kernel of a first one of the two convolutional layers is 7×7, and the convolutional kernel of a second one of the two convolutional layers is 5×5.

5. The method as claimed in claim 1, wherein the extracting a plurality of features of different scales of the basic feature to determine a multi-scale feature of the depth image comprises:
inputting the basic feature into a multi-scale feature extraction network, and outputting the multi-scale feature of the depth image;
wherein the multi-scale feature extraction network comprises N convolutional networks sequentially connected, and N is an integer greater than 1.

6. The method as claimed in claim 5, wherein each of the N convolutional networks comprises:
at least two convolutional branches and a concatenating network, and different ones of the at least two convolutional branches are configured to extract features of different scales, respectively;
wherein the inputting the basic feature into a multi-scale feature extraction network, and outputting the multi-scale feature of the depth image comprises:
inputting an output feature of a (i−1)th convolutional network into an ith convolutional network, and outputting features of the at least two convolutional branches of the ith convolutional network, where i is an integer changed from 1 to N, and a feature input into a first convolutional network is the basic feature;
inputting, into the concatenating network for features concatenation, the features output by and the feature input into the ith convolutional network, and outputting an output feature of the ith convolutional network;
continuing inputting the output feature of the ith convolutional network into a (i+1)th convolutional network, when i is smaller than N;
outputting, by an Nth convolutional network, the multi-scale feature of the depth image, when i is equal to N.

7. The method as claimed in claim 6, wherein each of the N convolutional networks comprises four the convolutional branches comprising:
a first convolutional branch, comprising a first convolutional layer;
a second convolutional branch, comprising a first pooling layer and a second convolutional layer sequentially connected;
a third convolutional branch, comprising a third convolutional layer and a fourth convolutional layer sequentially connected; and
a fourth convolutional branch, comprising a fifth convolutional layer, a sixth convolutional layer and a seventh convolutional layer sequentially connected;
wherein the first convolutional layer, the second convolutional layer, the fourth convolutional layer and the seventh convolutional layer have equal number of channels, and the third convolutional layer and the fifth convolutional layer have equal number of channels less than the number of channels of the fourth convolutional layer.

8. The method as claimed in claim 7, wherein:
convolutional kernels of the respective first through seventh convolutional layers are different ones selected from the group consisting of 1×1, 3×3, and 5×5;
a convolutional kernel of the first pooling layer is one selected from the group consisting of 1×1, 3×3, and 5×5; and
the convolutional kernel of the fifth convolutional layer is smaller than the convolutional kernel of the seventh convolutional layer.

9. The method as claimed in claim 1, wherein the up-sampling the multi-scale feature to determine a target feature comprises:
inputting the multi-scale feature into an eighth convolutional layer, and outputting the target feature;
wherein a number of channels of the eighth convolutional layer is M times of a number of channels of the multi-scale feature, and M is greater than 1.

10. A feature extraction device comprising:
a processor and a memory coupled to the processor;
wherein the memory is configured to store a computer program, and the processor is configured to call and run the computer program stored in the memory to execute a feature extraction method comprising:
extracting a feature of a depth image to be recognized, by a feature extraction network comprising at least one convolutional layer and at least one pooling layer alternately connected, to determine a basic feature of the depth image;
extracting a plurality of features of different scales of the basic feature, by a multi-scale feature extraction network comprising N convolutional networks sequentially connected, to determine a multi-scale feature of the depth image, wherein N is an integer greater than 1, and at least one of the N convolutional networks each comprises at least two convolutional branches and a concatenating network, and different ones of the at least two convolutional branches are configured to extract features of different scales, respectively; and
up-sampling the multi-scale feature, by a convolutional layer having a number of channels is M times of a number of channels of the multi-scale feature, to determine a target feature, wherein M is greater than 1, and the target feature is configured to determine a bounding box of a region of interest (RoI) in the depth image.

11. A pose estimation method comprising:
extracting a feature of a depth image to be recognized to determine a basic feature of the depth image;
extracting a plurality of features of different scales of the basic feature to determine a multi-scale feature of the depth image;
up-sampling the multi-scale feature to determine a target feature;
extracting, based on the target feature, a bounding box of a RoI;
extracting, based on the bounding box, coordinate information of keypoints in the RoI;
performing pose estimation, based on the coordinate information of the keypoints in the RoI, on a detection object, to determine a pose estimation result.

12. The method as claimed in claim 11, wherein the detection object comprises a hand, and the keypoints comprise at least one selected from the group consisting of finger joint points, fingertip points, a wrist key point and a palm center point.

13. The method as claimed in claim 11, wherein the extracting a feature of a depth image to be recognized to determine a basic feature of the depth image comprises:
inputting the depth image to be recognized into a feature extraction network to perform multiple times of down-sampling, and outputting the basic feature of the depth image.

14. The method as claimed in claim 13, wherein the feature extraction network comprises at least one convolutional layer and at least one pooling layer connected at intervals, and a starting layer is one of the at least one convolutional layer; and in the at least one convolutional layer, a convolutional kernel of the convolutional layer close to an input end is larger than or equal to a convolutional kernel of the convolutional layer far away from the input end.

15. The method as claimed in claim 14, wherein the feature extraction network comprises two the convolutional layers and two the pooling layers, the convolutional kernel of a first one of the two convolutional layers is 7×7, and the convolutional kernel of a second one of the two convolutional layers is 5×5.

16. The method as claimed in claim 11, wherein the extracting a plurality of features of different scales of the basic feature to determine a multi-scale feature of the depth image comprises:
inputting the basic feature into a multi-scale feature extraction network, and outputting the multi-scale feature of the depth image;
wherein the multi-scale feature extraction network comprises N convolutional networks sequentially connected, and N is an integer greater than 1.

17. The method as claimed in claim 16, wherein each of the N convolutional networks comprises:
at least two convolutional branches and a concatenating network, and different ones of the at least two convolutional branches are configured to extract features of different scales, respectively;
wherein the inputting the basic feature into a multi-scale feature extraction network, and outputting the multi-scale feature of the depth image comprises:
inputting an output feature of a (i−1)th convolutional network into an ith convolutional network, and outputting features of the at least two convolutional branches of the ith convolutional network, where i is an integer changed from 1 to N, and a feature input into a first convolutional network is the basic feature;
inputting, into the concatenating network for features concatenation, the features output by and the feature input into the ith convolutional network, and outputting an output feature of the ith convolutional network;
continuing inputting the output feature of the ith convolutional network into a (i+1)th convolutional network, when i is smaller than N;
outputting, by an Nth convolutional network, the multi-scale feature of the depth image, when i is equal to N.

18. The method as claimed in claim 17, wherein each of the N convolutional networks comprises four the convolutional branches comprising:
a first convolutional branch, comprising a first convolutional layer;
a second convolutional branch, comprising a first pooling layer and a second convolutional layer sequentially connected;
a third convolutional branch, comprising a third convolutional layer and a fourth convolutional layer sequentially connected; and
a fourth convolutional branch, comprising a fifth convolutional layer, a sixth convolutional layer and a seventh convolutional layer sequentially connected;
wherein the first convolutional layer, the second convolutional layer, the fourth convolutional layer and the seventh convolutional layer have equal number of channels, and the third convolutional layer and the fifth convolutional layer have equal number of channels less than the number of channels of the fourth convolutional layer.

19. The method as claimed in claim 18, wherein:
convolutional kernels of the respective first through seventh convolutional layers are different ones selected from the group consisting of 1×1, 3×3, and 5×5;
a convolutional kernel of the first pooling layer is one selected from the group consisting of 1×1, 3×3, and 5×5;
the convolutional kernel of the first pooling layer is different from the convolutional kernel of the second convolutional layer; and
the convolutional kernel of the third convolutional layer is different from the convolutional kernel of the fourth convolutional layer.

20. The method as claimed in claim 11, wherein the up-sampling the multi-scale feature to determine a target feature comprises:
inputting the multi-scale feature into an eighth convolutional layer, and outputting the target feature;
wherein a number of channels of the eighth convolutional layer is M times of a number of channels of the multi-scale feature, and M is greater than 1.
